(19) United States
(12) Patent Application Publication
(10) Pub. No.: US 2012/0188217 A1
(43) Pub. Date: Jul. 26, 2012

(54) DISPLAY DEVICE

(75) Inventor: Tsuyoshi Hasegawa, Daito City (JP)

(73) Assignee: SANYO ELECTRIC CO., LTD., Moriguchi City (JP)

(21) Appl. No.: 13/348,808

(22) Filed: Jan. 12, 2012

(30) Foreign Application Priority Data
Jan. 25, 2011 (JP) 2011-012509

(51) Int. Cl. G09G 5/00

(52) U.S. Cl. 345/211

(57) ABSTRACT

A display device including a plurality of LEDs and driving the LEDs by supplying different currents to the LEDs comprises a control portion which performs control such that a current value of a current that is supplied to each of the LEDs is changed each time a predetermined period of time passes or each time a power supply of the display device is turned on.

This application is based on Japanese Patent Application No. 2011-012509 filed on Jan. 25, 2011, the contents of which are hereby incorporated by reference.

### BACKGROUND OF THE INVENTION

1. Field of the Invention

The present invention is related to a display device that uses an LED (light emitting diode) as a light source.

2. Description of the Related Art

Recently, display devices such as a liquid crystal display device which used an LED as light source in substitution for a fluorescent tube have been becoming increasingly common.

A display device which uses an LED as a light source is provided with a plurality of channels (CH) of LEDs. In a so-called direct-type liquid crystal display device, LEDs of a plurality of channels are arranged on a surface thereof that faces a liquid crystal panel. On the other hand, in a so-called edge-type liquid crystal display device, LEDs of a plurality of channels are arranged on a side surface of a light guide plate, and light emitted from the LEDs is guided from an upper surface to a liquid crystal panel.

Here, one of LED driving methods that are mainly used in direct-type liquid crystal display devices is called “local dimming”. The local dimming is a driving method in which a liquid crystal panel is divided into a plurality of regions, and a light amount of an LED of each channel is adjusted independently on a region-by-region basis according to brightness of a corresponding region of an image to be displayed. This method makes it possible to display a clear image with reduced power consumption.

With the local dimming, the LEDs are driven by supplying currents of different levels to LEDs of different channels, and, lives of the LEDs depend on the current values and thus depend on temperature.

### SUMMARY OF THE INVENTION

According to one aspect of the present invention, a display device including a plurality of LEDs and driving the LEDs by supplying different currents to the LEDs comprises a control portion which performs control such that a current value of a current that is supplied to each of the LEDs is changed each time a predetermined period of time passes or each time a power supply of the display device is turned on.

According to another aspect of the present invention, a display device including a plurality of LEDs and performing local dimming by dividing a displayed image into regions and supplying a current to each of the LEDs according to brightness of each of the regions comprises a calculation portion which calculates accumulated current-consumption values of the LEDs while the local dimming is performed, and a control portion which performs control based on the accumulated current-consumption values calculated by the calculation portion such that a current is supplied to each of the LEDs such that the accumulated current-consumption values of the LEDs are equal to each other.

### DESCRIPTION OF THE DRAWINGS

FIG. 1 is a diagram schematically showing the structure of a liquid crystal display device embodying the present invention;

FIG. 2 is an exploded perspective view schematically showing the structure of a liquid crystal display device according to a first embodiment of the present invention;

FIG. 3 is a flow chart of an example of LED drive control according to the first embodiment of the present invention;

FIG. 4 is a flow chart of another example of LED drive control according to the first embodiment of the present invention; and

FIG. 5 is a flow chart of LED-life variation eliminating process according to a second embodiment of the present invention.

### DESCRIPTION OF THE PREFERRED EMBODIMENTS

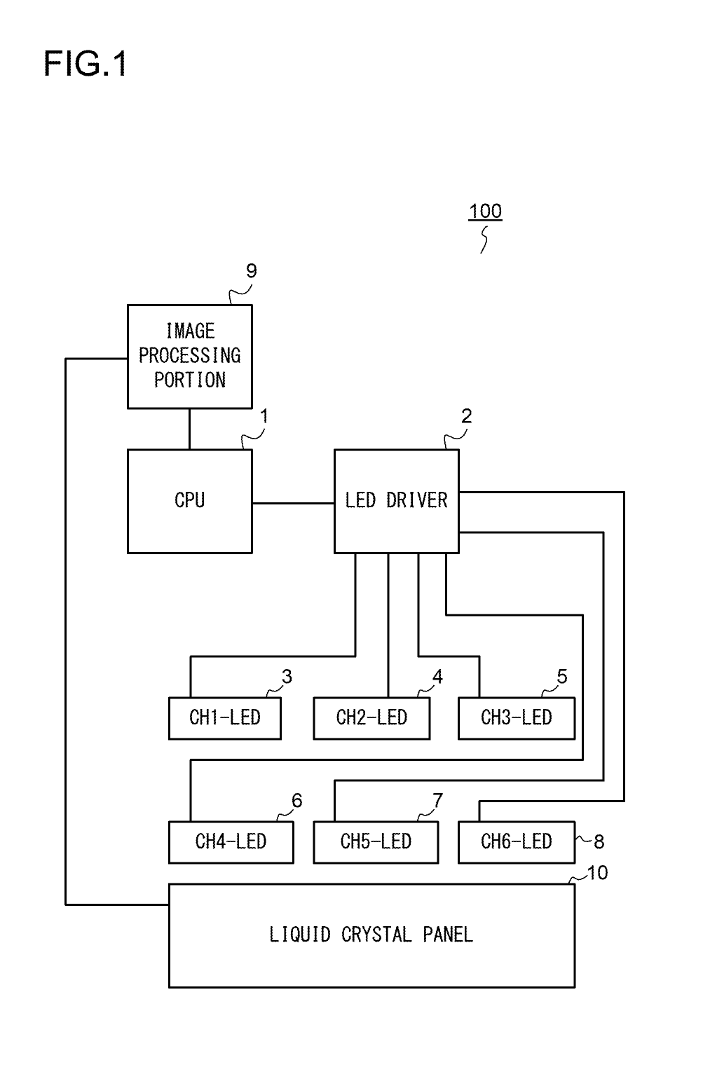

Hereinafter, an embodiment of the present invention will be described with reference to the accompanying drawings. The structure of a liquid crystal display device 100 embodying the present invention is schematically shown in FIG. 1. The liquid crystal display device 100 may be, for example, a display device as a television receiver (such as a digital terrestrial television receiver) or a monitor for a personal computer, or may be a display device as a so-called digital signage (an advertisement medium that makes use of digital technologies in display and communication to display images and information).

The liquid crystal display device 100 shown in FIG. 1 is provided with a CPU (central processing unit) 1, an LED driver 2, a CH1-LED 3, a CH2-LED 4, a CH3-LED 5, a CH4-LED 6, a CH5-LED 7, a CH6-LED 8, an image processing portion 9, and a liquid crystal panel 10. Incidentally, if the liquid crystal display device 100 is, for example, a television receiver, it is naturally provided with a tuner for receiving television broadcast, a demodulation circuit, etc., but such components are omitted in FIG. 1.

The CPU 1 is an operation processing unit which performs overall control of the liquid crystal display device 100, and executes a control program stored in an ROM which is not illustrated. The LED driver 2 drives the LEDs (the CH1-LED 3 to the CH6-LED 8) of the plurality of channels by supplying a current to each of them based on an instruction from the CPU 1. As a current-supplying method, one in which a pulse current of a value that is constant (for example, at 60 mA) in an ON state is supplied to each of the LEDs is adopted. Here, a duty ratio of the pulse is changeable. Incidentally, instead of a pulse current, a direct current may be supplied by changing its value.

In a case in which the liquid crystal display device 100 shown in FIG. 1 is of the direct type, the LEDs of the channels, namely, the CH1-LED 3 to the CH6-LED 8 are arranged on a surface that faces the liquid crystal panel 10. Here, the CH1-LED 3, the CH2-LED 4, and the CH3-LED 5 are arranged side by side in a lateral row in an upper portion of the device while the CH4-LED 6, the CH5-LED 7, and the CH6-LED 8 are arranged side by side in a lateral row in a lower portion of the device. In addition, an unillustrated diffusion sheet, for example, is disposed between the LEDs arranged in this way and the liquid crystal panel 10. With this arrangement, light emitted from the LEDs of the channels is diffused by the diffusion sheet, and then illuminates the liquid crystal panel 10 from behind.

On the other hand, in a case in which the liquid crystal display device 100 shown in FIG. 1 is of the edge type, an unillustrated light guide plate is disposed to face the liquid crystal panel 10, on a side surface of which the LEDs of the channels are disposed. The CH1-LED 3, the CH2-LED 4, and the CH3-LED 5 are arranged side by side on an upper side surface of the light guide plate while the CH4-LED 6, the CH5-LED 7, and the CH6-LED 8 are arranged side by side on a lower side surface of the light guide plate. In addition, an unillustrated reflection sheet is disposed behind the light guide plate, and, for example, a diffusion sheet is disposed between the light guide plate and the liquid crystal panel 10. With this arrangement, light emitted from the LEDs of the channels disposed on the upper and lower side surfaces of the light guide plate is diffused inside the light guide plate to pass through, for example, the diffusion sheet, and illuminates the liquid crystal panel 10 from behind.

The image processing portion 9 receives an image signal such as a broadcast image signal and an advertisement image signal, and drives the liquid crystal panel 10 to display an image based on the received image signals. The image processing portion 9 also drives the liquid crystal panel 10 according to an instruction from the CPU 1 to display an OSD (on screen display) image.

### First Embodiment

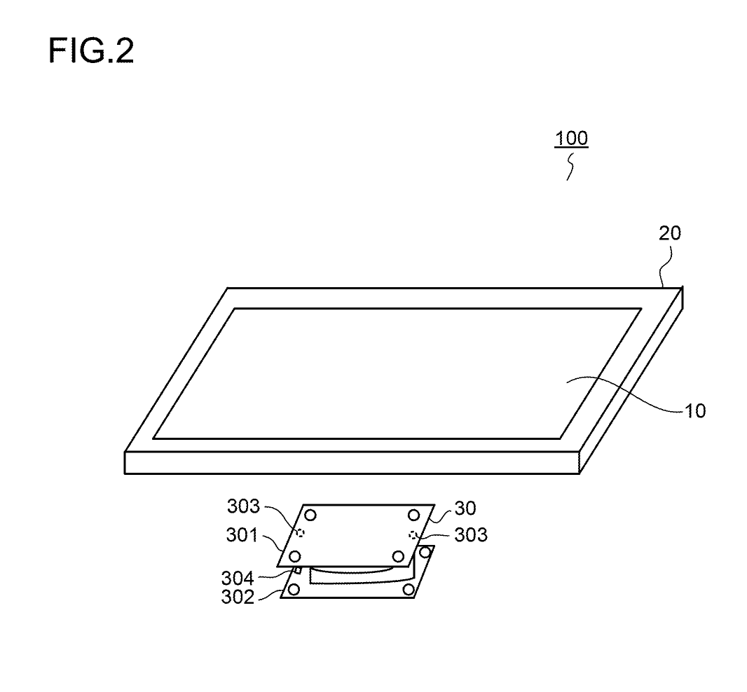

The liquid crystal display device 100 has the arrangement described above, and the liquid crystal display device 100 as a first embodiment further has an arrangement shown in FIG. 2. FIG. 2 is an exploded perspective view schematically showing the liquid crystal display device 100 as the first embodiment of the present invention. The liquid crystal display device 100 is proved with a display portion 20 and a support member 30. The display portion 20 has the arrangement shown in FIG. 1 accommodated in a housing. The support member 30 is a member for setting the liquid crystal display device 100 on a wall or a support base when in use, and the support member 30 has a front surface member 301 on a front surface side thereof and a back surface member 302 on a back surface side thereof. The front surface member 301 is couple to the back surface member 302 to be rotatable by 180° with respect to the back surface member 302. In addition, a magnet 303 is disposed at each of right and left ends of a fitting portion for fitting the front surface member 301 to the display portion 20. And, at an end of a fitting portion for fitting the back surface member 302 to the wall or the support base, a hall element 304 is disposed at a position that faces the magnet 303.

Variation of a voltage outputted from the hall element 304 is detected. Specifically, voltage variation from a voltage outputted from the hall element 304 in a state in which the magnet 303 and the hall element 304 face each other, via a voltage outputted from the hall element 304 in a state in which the magnet 303 and the hall element 304 do not face each other, to a voltage outputted from the hall element 304 in a state in which the magnet 303 and the hall element 304 face each other again is detected. By detecting this voltage variation, it is possible to detect that the front surface member 301 has rotated by 180°, that is, the display portion 20 has rotated by 180°.

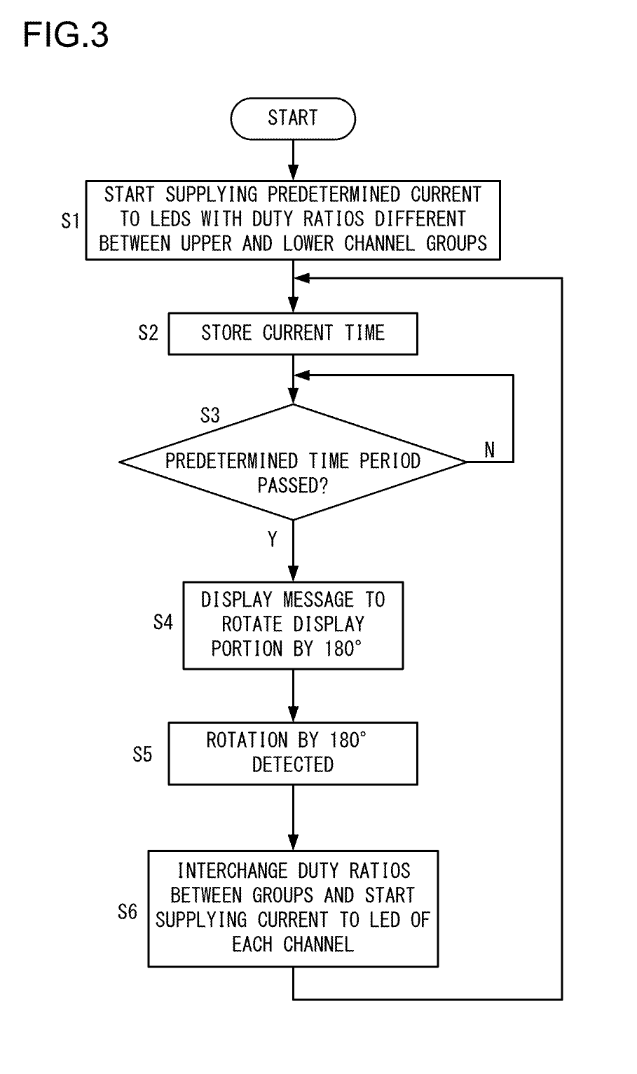

Next, LED drive control performed in the liquid crystal display device 100 as the first embodiment of the present invention will be described with reference to a flow chart shown in FIG. 3.

The flow shown in the flow chart of FIG. 3 starts, for example, when a power supply of the liquid crystal display device 100 is turned on. First, in step S1, according to an instruction from the CPU 1, the LED driver 2 starts to supply a current to the LED of each channel. At this time, a pulse current of a predetermined first duty ratio (for example, 40%) is supplied to the CH1-LED 3, the CH2-LED 4. and the CH3-LED 5 positioned in the upper portion, and a pulse current of a predetermined second duty ratio (for example, 80%), which is larger than the first duty ratio, is supplied to the CH4-LED 6, the CH5-LED 7, and the CH6-LED 8 positioned in the lower portion. In an ON state, current values supplied to the LEDs in the upper and lower portions are the same (for example, 60 mA).

Next, in step S2, the CPU 1 stores current time of a time point in an unillustrated memory. Then, the CPU 1 judges from a difference between current time of another time point and the current time stored in the memory whether or not a predetermined period of time has passed (step S3). If it is judged that the predetermined period of time has not passed (N in step S3), the judgment is performed again. If it is judged that the predetermined period of time has passed (Y in step S3), the flow proceeds to step S4.

In step S4, according to an instruction from the CPU 1, the image processing portion 9 displays on the liquid crystal panel 10 a message to urge a user to rotate the display portion 20 (FIG. 2) by 180°. Then, in step S5, the CPU 1 starts to monitor an output voltage of the hall element 304 (FIG. 2), and judges that the display portion 20 has been rotated by 180° by the user when it detects the above mentioned voltage variation.

Then, in step S6, according to an instruction from the CPU 1, the LED driver 2 starts to supply a current to each of the LEDs of a group of the CH1-LED 3, the CH2-LED 4, and the CH3-LED 5, and to supply a current to each of the LEDs of a group of the CH4-LED 6, the CH5-LED 7, and the CH6-LED 8, with the duty ratios interchanged between the two groups. Thereafter, the flow returns to step S2, and then the same operations are repeated.

In this way, the duty ratio of the current that is supplied to the group of the CH1-LED 3, the CH2-LED 4, and the CH3-LED 5 and the duty ratio of the current that is supplied to the group of the CH4-LED 6, the CH5-LED 7, and the CH6-LED 8 are interchanged each time the predetermined period of time passes, and this makes it possible to uniformize the lives of the LEDs of all the channels.

Also, when the predetermined period of time passes, the user, being urged by the displayed message, rotates the display portion 20 by 180°. Air heated by heat generated by the LEDs moves upward, and thus temperature is more likely to rise in the upper portion than in the lower portion. The display portion 20 rotates so that the groups of channels take turns to be positioned in the upper and lower portions in such conditions, and this makes it possible to further uniformize the lives of the LEDs of all the channels.

Also, at this time, the duty ratios of the groups of channels are interchanged such that whichever of the groups of channels is positioned in the lower portion has a larger duty ratio than whichever of the groups of channels is positioned in the upper portion. As a result, whichever of the groups of channels is positioned in the lower portion is supplied with a current with the larger duty ratio and is thus heated up to a high temperature, but air heated by whichever of the groups of channels is positioned in the lower portion moves upward. Thus, whichever of the groups of channels is positioned in the lower portion is prevented from being heated to excess. Besides, although the heated air moves from the lower portion to the upper portion, the temperature of whichever of the groups of channels is positioned in the upper portion does not rise to an excessively high temperature, either, thanks to the small duty ratio. As a result, it is possible to make the lives of the LEDs of all the channels longer and thus to achieve a long life of the display device as a whole.

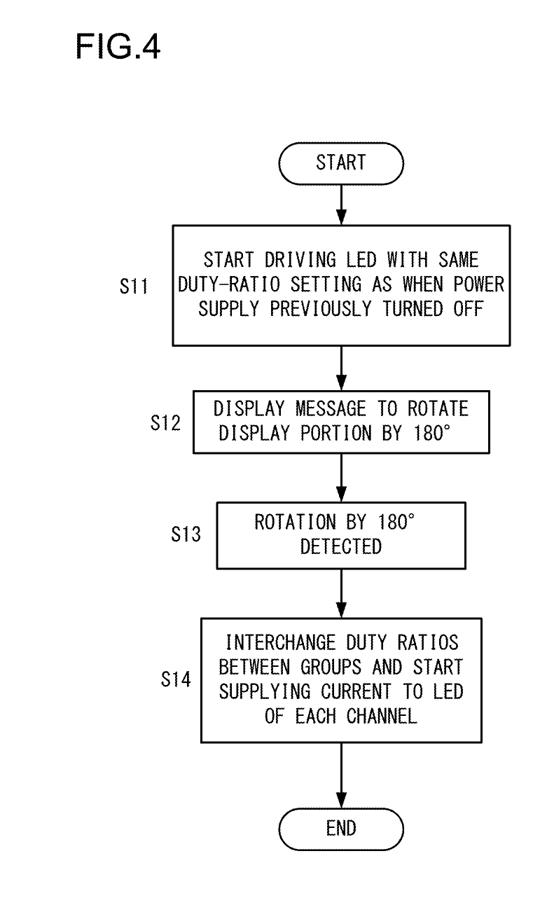

Another embodiment of the LED drive control is shown in the flow chart of FIG. 4. The flow shown in the flow chart of FIG. 4 starts when the power supply of the liquid crystal display device 100 is turned on. First, in step S11, according to an instruction from the CPU 1, the LED driver 2 starts to supply a current to the LED of each channel with the same duty ratio as when the power supply is turned off last. At this time, the group of channels positioned in the lower portion has a larger duty than the group of channels positioned in the upper portion.

Next, in step S12, according to an instruction from the CPU 1, the image processing portion 9 displays on the liquid crystal panel 10 a message to urge the user to rotate the display portion 20 by 180°. Then, in step S13, the CPU 1 starts to monitor an output voltage of the hall element 304 (FIG. 2), and judges that the display portion 20 has been rotated by 180° by the user when it detects the above mentioned voltage variation.

Then, in step S14, according to an instruction from the CPU 1, the LED driver 2 starts to supply a current to each of the LEDs of a group of the CH1-LED 3, the CH2-LED 4, and the CH3-LED 5, and to supply a current to each of the LEDs of a group of the CH4-LED 6, the CH5-LED 7, and the CH6-LED 8, with the duty ratios interchanged between the two groups. Thereafter, the current setting remains constant until the power supply is turned off.

The LED drive control according to this embodiment is also successful in achieving the same effect as has been stated above in relation to the previous embodiment.

In the embodiments described above, the user is requested to rotate the display portion 20; instead of this, however, the display portion 20 may be automatically rotated by 180° after the predetermined period of time has passed or when the power supply is turned on. In this case, a drive mechanism (such as a motor and a reducer) for rotating the display portion 20 is provided, for example, in the support member 30.

Also, in the liquid crystal display device 100 as an embodiment of the present invention, an amount of light emitted from the LEDs of a group of channels positioned in the upper portion differ from an amount of light emitted from the LEDs of a group of channels positioned in the lower portion, and thus, from the viewpoint of reducing uneven brightness on a display screen, it is preferable to adopt an edge-type liquid crystal display device.

Also, in this embodiment, a direct current may be used instead of a pulse current to drive the LEDs, and in such a case, currents of different values are supplied to the LEDs of the groups of channels positioned in the upper and lower portions.

### Second Embodiment

Next, another embodiment will be described. A liquid crystal display unit 100 as the second embodiment is a display device having a local dimming function and is preferably of the direct type. The mechanism of rotating the display portion in the first embodiment is not necessarily required in the second embodiment.

In the local dimming, a liquid crystal panel 10 is divided into a plurality of regions corresponding to the LEDs of all the channels, and a CPU 1 determines a current to be supplied to the LED of each of the channels independently, on a region-by-region basis, according to brightness of a corresponding region of an image to be displayed. Specifically, the CPU 1 determines a duty ratio of a current. And, according to an instruction from the CPU 1, an LED driver 2 starts to supply a current to the LED of each channel with the determined duty ratio.

While the local dimming is performed, the CPU 1 calculates an accumulated current-consumption value by accumulating values obtained by using a formula: (duty ratio)×(ON time current value)×(time). The accumulated current-consumption value serves as an indicator of the life of the LED of each channel (it is presumable that the larger the accumulated current-consumption value is, the shorter the life is). The local dimming makes it possible to display a clear image with a reduced amount of power consumption, but it causes variation in the accumulated current-consumption values of the LEDs of the plurality of channels, that is, variation in lives of the LEDs.

Assuming, for example, that the duty ratios for the channels are constant, the ON-time current value is 60 mA, and operating time is 10 hours for ease of explanation, the accumulated current-consumption value of each channel is as follows (the duty ratio of each channel, which depends on a displayed image, is not constant in practice):

CH1: 50%×60 mA×10 h=300,

CH2: 70%×60 mA×10 h=420,

CH3: 80%×60 mA×10 h=480,

CH4: 40%×60 mA×10 h=240,

CH5: 60%×60 mA×10 h=360, and

CH6: 50%×60 mA×10 h=300.

In this example, the CH3-LED 5 (FIG. 1), which has a largest accumulated current-consumption value, is presumed to have a shortest life.

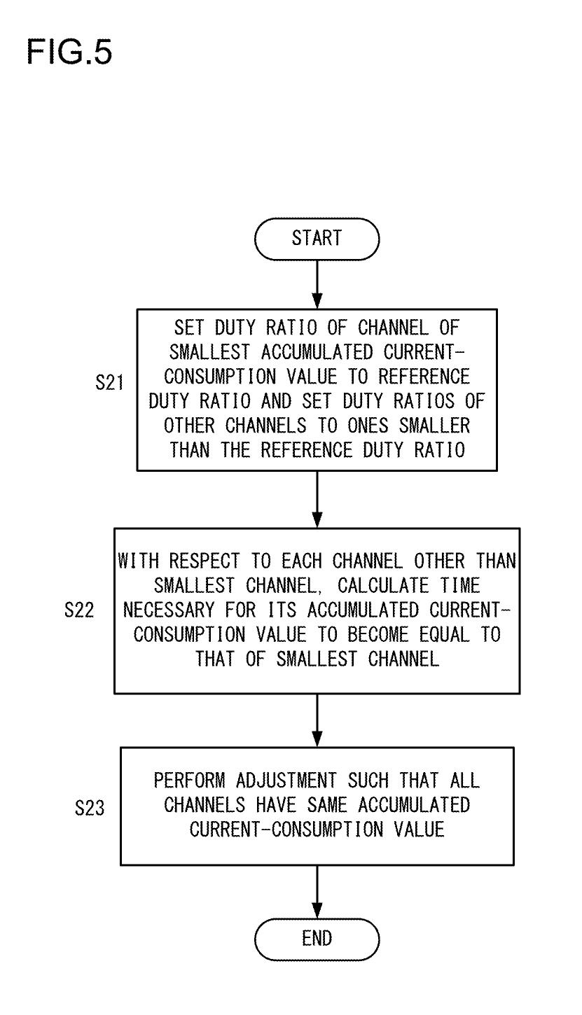

To deal with this, in this embodiment, processing is performed to eliminate the variation of the lives of the LEDs resulting from the local dimming. A flow chart of the processing to eliminate the variation of the lives is shown in FIG. 5. The flow shown in the flow chart of FIG. 5 may be started when the operating time reaches a predetermined period of time, or may be started when the accumulated current-consumption value of at least one channel becomes equal to a specified value or larger.

The flow shown in the flow chart of FIG. 5 starts with step S21, in which the CPU 1 sets the duty ratio of a channel having a smallest accumulated current-consumption value (hereinafter, the smallest channel) to a reference duty ratio, and the CPU 1 sets the duty ratios of the other channels to predetermined duty ratios that are smaller than the reference duty ratio.

For example, in the above example, the duty ratio of the CH4 having the smallest accumulated current-consumption value is set to 80%, which is the reference duty ratio, and the duty ratios of the other channels (CH1, CH2, CH3, CH5, CH6)are set to 60%, which is smaller than 80%.

Next, in step S22, the CPU 1 calculates, with respect to each of the channels other than the smallest channel, a period of time necessary for the accumulated current-consumption value to become equal to the accumulated current-consumption value of the smallest channel. The period of time, which will be denoted by Tc can be calculated by a formula: Tc=(Ic−1 min)/((D1−D2)×Ion), where

Ic: an accumulated current-consumption value of a target channel;

Imin: an accumulated current-consumption value of the smallest channel;

D1: a reference duty ratio;

D2: a predetermined duty ratio smaller than the reference duty ratio; and

Ion: ON-time current value.

For example, with respect to the above example, the period of time Tc is calculated as follows:

CH1: (300−240)/((80%−60%)×60 mA)=5 h,

CH2: (420−240)/((80%−60%)×60 mA)=15 h,

CH3: (480−240)/((80%−60%)×60 mA)=20 h,

CH5: (360−240)/((80%−60%)×60 mA)=10 h, and

CH6: (300−240)/((80%−60%)×60 mA)=5 h.

Next, in step S23, adjustment is performed such that all the channels have the same accumulated current-consumption value. Specifically, according to an instruction from the CPU 1, the LED driver 2 drives the LEDs such that the LED of the smallest channel is driven with the set duty ratio (the reference duty ratio) for a longest period of time Tc calculated as described above. Furthermore, the LED of a channel whose calculated period of time Tc described above is the longest is driven for a period of time corresponding to the calculated period of time Tc with the set duty ratio (that is smaller than the reference duty ratio). Moreover, the LEDs of the other channels are driven for their respective calculated periods of time Tc with the respective set duty ratios (that are smaller than the reference duty ratio), and thereafter, driven with the reference duty ratio for periods of time corresponding to differences between their respective calculated periods of time Tc and the longest of the calculated periods of time Tc.

For example, in the above example, with respect to the CH4-LED 6 (FIG. 1), which is the smallest channel, the LED is driven for 20 hours (the period of time Tc for the CH3 is the longest) with the reference duty ratio of 80%. Furthermore, with respect to the CH3-LED 5 whose period of time Tc is the longest, the LED is driven for 20 hours with the duty ratio of 60%. Moreover, with respect to the other channels, the LEDs are driven in the following manner:

CH1-LED 3: with the duty ratio of 60% for five hours and then with the reference duty ratio 80% for 15 hours;

CH2-LED 4: with the duty ratio of 60% for 15 hours and then with the reference duty ratio of 80% for five hours;

CH1-LED 7: with the duty ratio of 60% for 10 hours and then with the reference duty ratio 80% for 10 hours; and

CH1-LED 8: with the duty ratio of 60% for five hours and then with the reference duty ratio 80% for 15 hours.

All the channels can have the same accumulated current-consumption value in this way, and thus the LEDs of all the channels can have the same length of life. This makes it possible to achieve a long life of the device as a whole. After step S23, the flow ends.

Incidentally, in this embodiment, in a case in which a direct current is used instead of a pulse current to drive an LED, since the local dimming is performed by changing the direct current value, the accumulated current-consumption value is calculated by accumulating values obtained by a formula:

(direct current value)×(time).

Within the spirit and scope of the invention, multiple variations and modifications can be made in the embodiments the invention described herein.

For example, instead of the upper and lower portions of the display device, the channels may be divided into two groups located in right and left sides of the display device and current values of the two groups are interchanged between them. Alternatively, current values of the channels may be changed such that the current values are shifted from a channel to a next adjacent channel.

The embodiments described herein deal with cases where the invention is applied to a liquid crystal display device, but the present invention is applicable to any other types of display devices using an LED as a light source. For example, the present invention may be applied to an advertisement display device having an LED light source placed behind an advertisement photograph.

What is claimed is:

1. A display device including a plurality of LEDs and driving the LEDs by supplying different currents to the LEDs, the display device comprising
a control portion which performs control such that a current value of a current that is supplied to each of the LEDs is changed each time a predetermined period of time passes or each time a power supply of the display device is turned on.

2. The display device of claim 1,
wherein
the plurality of LEDs are composed of a first LED group in which LEDs are arranged side by side in a lateral row in one of upper and lower portions of the display device and a second LED group in which LEDs are arranged side by side in a lateral row in another of the upper and lower portions of the display device; and
the control portion interchanges current values between the first LED group and the second LED group each time the predetermined period of time passes or each time a power supply of the display device is turned on.

3. The display device of claim 2, further comprising:
a display portion which has the plurality of LEDs and which is rotatable by 180°;
a notice portion which gives a notice to urge a user to rotate the display portion by 180° each time the predetermined period of time passes or each time the power supply of the display device is turned on; and
a detection portion which detects that the display portion has been rotated by 180° after the notice is given,
wherein,
when the detection is done, the control portion interchanges the current values between the first LED group and the second LED group.

4. The display device of claim 3,
wherein
the current values are interchanged such that whichever of the first LED group and the second LED group is positioned in the lower portion of the display device is given a larger current value than whichever of the first LED group and the second LED group is positioned in the upper portion of the display device.

5. A display device including a plurality of LEDs and performing local dimming by dividing a displayed image into regions and supplying a current to each of the LEDs according to brightness of each of the regions, the display device comprising:
a calculation portion which calculates accumulated current-consumption values of the LEDs while the local dimming is performed; and
a control portion which performs control based on the accumulated current-consumption values calculated by the calculation portion such that a current is supplied to each of the LEDs such that the accumulated current-consumption values of the LEDs are equal to each other.
